(19) United States
(12) Patent Application Publication
(10) Pub. No.: US 2010/0112359 A1
(43) Pub. Date: May 6, 2010

(54) TITANIUM DIOXIDE COATINGS HAVING BARRIER LAYERS AND METHODS OF FORMING TITANIUM DIOXIDE COATINGS HAVING BARRIER LAYERS

(76) Inventors: Pramod K. Sharma, Ann Arbor, MI (US); Scott Thomsen, South Lyon, MI (US)

Correspondence Address: O'BRIEN JONES, PLLC, 1951 Kidwell Drive, Suite 550 B, Tyson's Corner, VA, 22182, US

(21) Appl. No.: 12/263,991

(22) Filed: Nov. 3, 2008

(51) Int. Cl. B32B 17/06; B05D 3/02; B32B 9/00

(52) U.S. Cl. 428/432; 427/372.2; 427/397.7; 428/702; 428/701; 428/689; 428/450

(57) ABSTRACT

Methods for forming titanium dioxide coatings are disclosed. At least one barrier layer is formed on a substrate. Sol-gel compositions are prepared and coated on the at least one barrier layer, and heated at a temperature sufficient to form an anatase titanium dioxide coating. Titanium dioxide coatings having at least one of improved visible light transmission properties, reflective properties, and/or haze are also disclosed.

### FIELD

The present invention relates generally to titanium dioxide coatings having at least one barrier layer and methods of forming titanium dioxide coatings having improved optical properties.

### BACKGROUND

Titanium dioxide (TiO₂, also know as titania) has been widely studied because of its potential photocatalytic applications. Titanium dioxide only absorbs ultraviolet (UV) radiation. When UV light is illuminated on titanium dioxide, electron-hole pairs are generated. Electrons are generated in the conduction band and holes are generated in the valence band. The electron and hole pairs reduce and oxidize, respectively, adsorbates on the surface of the titanium dioxide, producing radical species such as OH⁻ and O₂⁻. Such radicals may decompose certain organic compounds. As a result, titanium dioxide coatings have found use in antimicrobial and self-cleaning coatings, for example on windows.

To activate the titanium dioxide to photogenerate these electron-hole pairs (i.e. photocatalytic activity), and thus to provide the titanium dioxide with antimicrobial and/or self-cleaning properties, titanium dioxide must be regularly dosed with photons of energy greater than or equal to about 3.0 eV (i.e., radiation having a wavelength less than about 413 nm). Depending on variables such as the structure, ingredients, and texture of titanium dioxide coatings, for example, dosing may takes several hours, such as, for example, 6 hours or more. Antimicrobial titanium dioxide coatings, therefore, must generally be exposed to UV radiation for at least 6 hours before achieving the full photocatalytic effect.

Efforts have been made to extend the energy absorption of titanium dioxide to visible light and to improve the photocatalytic activity of titanium dioxide. For example, foreign metallic elements such as silver can be added. This may, for example, aid electron-hole separation as the silver can serve as an electron trap, and can facilitate electron excitation by creating a local electric field. The use of silver, however, requires tempering the coating in a nitrogen environment to prevent the silver from oxidizing. Thus, adding silver to titanium dioxide coatings on a large scale is not a viable option due to the high costs.

Titanium dioxide also has been shown to exhibit highly hydrophilic properties when exposed to UV radiation. Such hydrophilicity may be beneficial in certain embodiments, such as, for example, certain coating embodiments. Without wishing to be limited in theory, it is believed that the photoinduced hydrophilicity is a result of photocatalytic splitting of water by the mechanism of the photocatalytic activity of the titanium dioxide, i.e., by the photogenerated electron-hole pairs. When exposed to UV radiation, the water contact angle of titanium dioxide coatings approaches 0°, i.e., superhydrophilicity.

Current coating methods involving titanium dioxide often result in a disadvantageous loss of optical performance. This may be due to migration of sodium ions from the substrate to the titanium dioxide coating during the formation of the titanium dioxide coating. For example, an anatase titanium dioxide coating formed on a glass substrate may turn yellow or exhibit increased haze/decreased transmission when heated at temperatures which may be used during the coating process, such as temperatures greater than 600° C. Yellowed coatings or coatings having diminished optical properties, including, for example, increased haze, decreased transmission, or increased reflection, are not desirable under certain conditions.

There is thus a long-felt need in the industry for methods for forming a titanium dioxide coating having improved optical properties such as haze, transmission, and/or reflective properties. The invention described herein may, in some embodiments, solve some or all of these needs.

### SUMMARY

In accordance with various exemplary embodiments of the invention, methods for improving at least one of the haze, transmission, and/or reflection properties of titanium dioxide coatings have now been discovered.

In accordance with various exemplary embodiments of the invention are provided methods for forming anatase titanium dioxide coatings having at least one barrier layer. At least one exemplary embodiment of the invention relates to methods for forming anatase titanium dioxide coatings comprising providing a substrate, forming at least one barrier layer on the substrate, preparing a sol-gel composition optionally comprising colloidal silica, coating the at least one barrier layer with the sol-gel composition, and then heating the coating to form an anatase titanium dioxide coating having improved optical properties.

Other exemplary embodiments of the invention relate to anatase titanium dioxide coatings having at least one improved optical property chosen from haze and/or transmission properties and/or reflective properties. Exemplary embodiments of the invention also include antimicrobial and/or self-cleaning coatings comprising anatase titanium coatings formed on a barrier layer. Further embodiments include a substrate coated with a barrier layer and a titanium dioxide coating according to various exemplary embodiments of the invention.

As used herein, “improved optical property” means any decrease in the haze or reflection of, or any increase in the amount of light transmitted by, the titanium dioxide coating when compared to coatings not according to various embodiments of the invention.

Throughout this disclosure, the terms “photocatalytic activity,” “antimicrobial properties,” and/or “self-cleaning properties” may be used interchangeably to convey that the antimicrobial and/or self-cleaning properties of the titanium dioxide coatings are a result of the photocatalytic activity of the coatings.

As used herein, the term “sol-gel composition” means a chemical solution comprising a titanium compound within the chemical solution that forms a polymerized titanium dioxide coating when the solvent is removed, such as by heating or any other means.

As used herein, the term “temperable” means a titanium dioxide coating that may be heated to a temperature sufficient to temper a substrate on which it is formed without forming rutile phase titanium dioxide.

As used herein, the term “laminate” means an object having a layered structure. For example, a laminate may comprise a substrate, such as glass, and a coating formed thereon, such as a barrier layer and/or a sol-gel coating. A laminate according to the present invention may be made by any process known in the art to produce layers or coatings.

As described herein, the invention relates to anatase titanium dioxide coatings having at least one barrier layer and methods of forming anatase titanium dioxide coatings having at least one improved optical property. In the following description, certain aspects and embodiments will become evident. It should be understood that the invention, in its broadest sense, could be practiced without having one or more features of these aspects and embodiments. It should be understood that these aspects and embodiments are merely exemplary and explanatory, and are not restrictive of the invention as claimed.

### BRIEF DESCRIPTION OF THE DRAWING

The following FIGURE, which is described below and which is incorporated in and constitutes a part of the specification, illustrates an exemplary embodiment of the invention and is not to be considered limiting of the scope of the invention, for the invention may admit to other equally effective embodiments.

FIG. 1 is a schematic of a titanium dioxide coating formed on a substrate according to an embodiment of the present invention.

### DESCRIPTION OF EXEMPLARY EMBODIMENTS

Reference will now be made to various exemplary embodiments of the invention, an example of which is illustrated in the accompanying FIGURE. However, these various exemplary embodiments are not intended to limit the disclosure, but rather numerous specific details are set forth in order to provide a thorough understanding of the invention. It will be apparent to one skilled in the art that the invention may be practiced without some or all of these specific details, and the disclosure is intended to cover alternatives, modifications, and equivalents. For example, well-known features and/or process steps may not have been described in detail so as not to unnecessarily obscure the invention.

The present invention contemplates various exemplary methods of forming anatase titanium dioxide coatings formed on at least one barrier layer in order to improve at least one of haze, visible light transmission, and/or reflectivity of the coating.

While not wishing to be bound by theory, it is believed that the at least one barrier layer prevents sodium ions from migrating from the substrate to the titanium dioxide layer. Sodium ions are believed to migrate from the substrate to its surface during heating, thereby decreasing the optical properties of the titanium dioxide coating by decreasing the number of available electron-hole pairs due to its physical presence and/or to absorb electrons, thus decreasing the photocatalytic activity of the titanium dioxide. In addition, sodium ions are also believed to discolor the titanium dioxide coatings, increase haze and reflection, and/or decrease visible light transmission through the titanium dioxide coating.

In at least one exemplary embodiment of the invention is disclosed a method of forming an anatase titanium dioxide coating on at least one barrier layer, the method comprising providing a substrate, forming at least one barrier layer on the substrate, preparing a titanium dioxide sol-gel composition, coating the at least one barrier layer with the sol-gel composition, and heating the coating to form an anatase titanium dioxide coating.

According to at least one embodiment of the present invention, the at least one barrier layer may comprise a material chosen from silicon nitride (Si₃N₄), zirconia, silicon, aluminum chloride (AlCl₃), aluminum oxide (Al₂O₃), or any other transparent material that acts as a barrier and does not disrupt the anatase phase of the titanium dioxide coating. In at least one embodiment, the at least one barrier layer comprises silicon nitride. In at least one embodiment, the titanium dioxide coating may be formed on more than one barrier layer, such as for example, two or more barrier layers formed on top of one another.

Processes for forming the barrier layer may include any process known to those of skill in the art which does not interfere with the desired properties of the product. In at least one embodiment, the at least one barrier layer may be formed by sputtering on the substrate. In at least one other embodiment, the at least one barrier layer is formed by a chemical vapor deposition (CVD) process, such as, for example, combustion chemical vapor deposition (CCVD). Other processes for forming the at least one barrier layer may be used and one skilled in the art would appreciate that the method used to deposit the at least one barrier layer depends on a variety of factors such as, for example, the substrate material, the material being deposited, the desired thickness of the layer, and the desired properties of the final product.

The thickness of the barrier layers formed may vary according to the desired properties of the final product, and the appropriate thickness of any layer for any particular embodiment is well within the ability of those skilled in the art to determine. For example, in at least one embodiment, the thickness of at least one barrier layer may range from about 10 nm to about 100 nm. In at least one further embodiment, at least one barrier layer may have a thickness ranging from about 20 nm to about 80 nm. One of skill in the art will recognize that the thickness of the at least one barrier layer may result in a tradeoff in desired properties, and may need to be varied appropriately. For example, thicker barrier layers may provide greater protection against the migration of sodium ions, but may lead to impaired optical properties, such as, for example, increased haze and/or decreased visible light transmission. In contrast, thinner barrier layers may allow for greater visible light transmission and/or lower haze, but may not provide as much protection against the migration of sodium ions.

In at least one exemplary embodiment, the titanium dioxide sol-gel composition comprises a titanium alkoxide or a titanium chloride. Examples of titanium alkoxides which may be used in sol-gel compositions according to the present invention include, but are not limited to, titanium n-butoxide, titanium tetra-iso-butoxide (TTIB), titanium isopropoxide, and titanium ethoxide. In at least one embodiment, the titanium dioxide sol-gel composition comprises titanium tetra-iso-butoxide.

In at least one embodiment, the sol-gel composition further comprises a surfactant, which may improve the coating process. Examples of surfactants which may be used in accordance with the present invention include, but are not limited to, non-ionic surfactants such as alkyl polysaccharides, alkylamine ethoxylates, castor oil ethoxylates, ceto-stearyl alcohol ethoxylates, decyl alcohol ethoxylates, and ethylene glycol esters.

In at least one embodiment, the sol-gel composition may further comprise colloidal silica or colloidal metal oxide. The colloidal silica or colloidal metal oxide may increase the surface roughness of the titanium dioxide coating. In at least one embodiment, the sol-gel composition comprises colloidal silica or colloidal metal oxide in an amount comprising at least 5 wt % relative to the total weight of the composition.

In various exemplary embodiments, the anatase titanium dioxide coatings may be formed on a substrate. Accordingly, coated substrates according to various exemplary embodiments of the invention are also contemplated herein. One of skill in the art will readily appreciate the types of substrates which may be coated with exemplary coatings as described herein. By way of example, the substrate may comprise a glass substrate. In various exemplary embodiments, the glass substrate may be chosen from standard clear glass, such as float glass, matte/matte, and matte/prismatic, or a low iron glass, such as ExtraClear™, UltraWhite™, or Solar glasses available from Guardian Industries.

In one exemplary embodiment, the substrate may have at least one barrier layer formed thereon, and may then be coated with the sol-gel composition by a method chosen from spin-coating the sol-gel composition on the at least one barrier layer, spray-coating the sol-gel composition on the at least one barrier layer, dip-coating the substrate having at least one barrier layer with the sol-gel composition, and any other technique known to those of skill in the art.

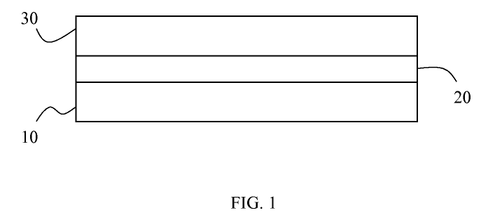

A schematic illustration of a titanium dioxide coating formed on a substrate with a barrier layer is shown in FIG. 1. As can be seen in FIG. 1, barrier layer 20 is formed on substrate 10. A titanium dioxide layer 30 is formed on barrier layer 20 such that the titanium dioxide layer is separated from substrate 10.

In one exemplary embodiment, the sol-gel coated substrate having at least one barrier layer may be heated at a temperature of 600° C. or greater, such as 625° C. or greater. In one exemplary embodiment, the sol-gel coated substrate may be heated for any length time sufficient to create an anatase titanium dioxide coating, such as, for example, about 3-4 minutes, such as, about 3½ minutes. One skilled in the art will appreciate, however, that other temperatures and heating times may be used and should be chosen such that anatase titanium dioxide is formed. For example, the sol-gel coated substrate having at least one barrier layer may be heated at a temperature ranging from about 550° C. to about 650° C. The sol-gel coated substrate having at least one barrier layer may be heated at lower temperatures as well, as long as anatase titanium dioxide is formed. Thus, one skilled in the art may choose the temperature and heating time based on, for example, the appropriate temperature and time for heating to form the anatase titanium dioxide coating on the at least one barrier layer, the properties of the desired titanium dioxide coating, such as thickness of the coating or thickness of the substrate and at least one barrier layer, etc. For example, a thinner coating may require heating at a lower temperature or for a shorter time than a thicker coating. Similarly, a substrate or at least one barrier layer that is thicker or has lower heat transfer may require a higher temperature or a longer time than a substrate or at least one barrier layer that is thinner or has a higher heat transfer. As used herein, the phrase “heated at” a certain temperature means that the heating means such as an oven or furnace is set at the specified temperature. Determination of the appropriate heating time and temperature is well within the ability of those skilled in the art, requiring no more than routine experimentation.

Temperable anatase titanium dioxide coatings may be formed according to at least one method of the present invention. For example, an anatase titanium dioxide coating formed on at least one barrier layer on a glass substrate may be heated at a temperature sufficient to temper the glass substrate without forming the rutile phase of titanium dioxide, i.e., the titanium dioxide remains in the anatase phase when the glass substrate is tempered.

Various exemplary methods in accordance with the invention may improve at least one of haze, visible light transmission, and/or reflectivity of the coatings.

In at least one embodiment, the titanium dioxide coating may be used as an antimicrobial and/or self-cleaning coating. Accordingly, a substrate having improved antimicrobial and/or self-cleaning properties, having at least one barrier layer and coated with a titanium dioxide coating according to various embodiments of the invention, can be provided. Antimicrobial and/or self-cleaning coatings according to the present invention may be used, for example, on windows. The antimicrobial and/or self-cleaning coatings according to the present invention may also be used for automobile windshields, house windows, building windows, shower doors, table tops, etc.

The present invention also contemplates an antimicrobial and/or self-cleaning laminate. According to at least one embodiment, the antimicrobial and/or self-cleaning laminate may comprise a substrate, at least one barrier layer on the substrate, and a titanium dioxide coating on the at least one barrier layer.

The present invention also contemplates, in at least one embodiment, a titanium dioxide coating having improved optical properties, such as, for example, when formed on at least one barrier layer.

The present invention is further illustrated by the following non-limiting examples, which are provided to further aid those of skill in the art in the appreciation of the invention.

Unless otherwise indicated, all numbers herein, such as those expressing weight percents of ingredients and values for certain physical properties, used in the specification and claims are to be understood as being modified in all instances by the term “about,” whether or not so stated. It should also be understood that the precise numerical values used in the specification and claims form additional embodiments of the invention. Efforts have been made to ensure the accuracy of the numerical values disclosed in the Examples. Any measured numerical value, however, can inherently contain certain errors resulting from the standard deviation found in its respective measuring technique.

As used herein, a “wt %” or “weight percent” or “percent by weight” of a component, unless specifically stated to the contrary, is based on the total weight of the composition or article in which the component is included. As used herein, all percentages are by weight unless indicated otherwise.

It is noted that, as used in this specification and the appended claims, the singular forms “a,” “an,” and “the,” include plural referents unless expressly and unequivocally limited to one referent, and vice versa. Thus, by way of example only, reference to “a substrate” can refer to one or more substrates, and reference to “a barrier layer” can refer to one or more barrier layers. As used herein, the term “include” and its grammatical variants are intended to be non-limiting, such that recitation of items in a list is not to the exclusion of other like items that can be substituted or added to the listed items.

It will be apparent to those skilled in the art that various modifications and variation can be made to the present disclosure without departing from the scope its teachings. Other embodiments of the disclosure will be apparent to those skilled in the art from consideration of the specification and practice of the teachings disclosed herein. It is intended that the embodiments described in the specification be considered as exemplary only.

### EXAMPLES

### Comparative Example 1

A titanium dioxide sol was prepared by mixing 6 grams of titanium tetra-iso-butoxide (TTIB) in a solution containing 25 grams of ethanol and 2 grams of nitric acid. The mixture was stirred for 1 hour. The pure titanium dioxide coating was fabricated by spin coating a glass substrate at 700 rpm for 30 seconds. The coating was heat treated in a furnace at 625° C. for 3½ minutes. The formed titanium dioxide coating was pure anatase phase titanium dioxide. The titanium dioxide coating had a visible light transmission of 79.4%, reflection at the film side of 16.5%, and 2.14% haze.

### Example 1

The titanium dioxide sol used to prepare the titanium dioxide coating of Example 1 was prepared similar to the titanium dioxide sol of Comparative Example 1. A barrier layer of silicon nitride was formed on a glass substrate by sputtering. The barrier layer had a thickness of 20 nm. The titanium dioxide sol was spin-coated on the barrier layer at 700 rpm for 30 seconds. The coating was then heat treated in a furnace at 625° C. for 3½ minutes. The formed titanium dioxide coating was pure anatase phase titanium dioxide. The visible light transmission of the titanium dioxide coating of Example 1 was 83.6%. The reflection at the film side and haze of the coating were 16% and 0.57%, respectively.

### Comparative Example 2

The titanium dioxide sol used to prepare the titanium dioxide coating of Comparative Example 2 was prepared similar to the titanium dioxide sol of Comparative Example 1. To the titanium dioxide sol was added 10 wt % of colloidal silica having a particle size of 70 nm (IPA-ST-Z1 from Nissan Chemical). The colloidal silica particles led to a rough surface of the titanium dioxide coating after spin-coating and heating was performed as above in Comparative Example 1.

The visible light transmission, reflectance at the film side, and haze of the coating of Comparative Example 2 were 81.7%, 15.67%, and 1.68%, respectively.

### Example 2

The titanium dioxide sol used to prepare the titanium dioxide coating of Example 2 was prepared similar to the titanium dioxide sol of Comparative Example 1. To the titanium dioxide sol was added 10 wt % of colloidal silica having a particle size of 70 nm (IPA-ST-Z1 from Nissan Chemical). A 20 nm silicon nitride barrier layer was formed on a glass substrate by sputtering. The colloidal silica particles led to a rough surface of the titanium dioxide coating after spin-coating, and heating was performed as above in Comparative Example 1.

The visible light transmission, reflectance at the film side, and haze of the coating of Example 2 were 82.9%, 15.2%, and 0.6%, respectively.

As evidenced by Examples 1 and 2, the anatase titanium dioxide coatings formed on barrier layers improved the optical properties of the anatase titanium dioxide. As can be seen by comparing the data from Comparative Example 1 and Example 1, the presence of the barrier layer enhanced the visible light transmission by 5.2% and decreased the reflection at the film side by 3%. In addition, the amount of haze decreased 73.3% when a barrier layer was added between the substrate and the titanium dioxide coating.

What is claimed is:

1. A method of forming an anatase titanium dioxide coating on a substrate, comprising:
providing a substrate;
forming at least one barrier layer on the substrate;
preparing a titanium dioxide sol-gel composition;
coating the at least one barrier layer with the sol-gel composition; and
heating the coated substrate to form an anatase titanium dioxide coating.

2. The method of claim 1, wherein the at least one barrier layer comprises at least one material chosen from silicon nitride, silicon, aluminum chloride, aluminum oxide, and zirconia.

3. The method of claim 2, wherein the at least one barrier layer comprises silicon nitride.

4. The method of claim 1, wherein the at least one barrier layer has a thickness ranging from about 10 nm to about 100 nm.

5. The method of claim 1, wherein the sol-gel composition further comprises colloidal metal oxide or colloidal silica.

6. The method of claim 1, wherein the substrate comprises a glass substrate.

7. The method of claim 6, wherein the glass substrate is chosen from clear glass and low-iron glass substrates.

8. The method of claim 1, wherein the coated substrate is heated at a temperature greater than about 600° C.

9. A method of improving at least one of visible light transmission properties, reflection properties, and haze of a titanium dioxide coating, comprising:
providing a substrate;
forming at least one barrier layer on the substrate;
preparing a titanium dioxide sol-gel composition;
coating the at least one barrier layer with the sol-gel composition; and
heating the coated substrate to form an anatase titanium dioxide coating.

10. The method of claim 9, wherein the at least one barrier layer comprises at least one material chosen from silicon nitride, silicon, aluminum chloride, aluminum oxide, and zirconia.

11. The method of claim 10, wherein the at least one barrier layer comprises silicon nitride.

12. The method of claim 9, wherein the at least one barrier layer has a thickness ranging from about 10 nm to about 100 nm.

13. The method of claim 9, wherein the sol-gel composition further comprises colloidal metal oxide or colloidal silica.

14. The method of claim 9, wherein the substrate is chosen from clear glass and low-iron glass.

15. The method of claim 9, wherein the coated substrate is heated at a temperature greater than about 600° C.

16. A laminate comprising:
a substrate;
at least one barrier layer formed on a surface of the substrate; and
an anatase titanium dioxide coating on the at least one barrier layer.

17. The laminate of claim 16, wherein the at least one barrier layer comprises at least one material chosen from silicon nitride, silicon, aluminum chloride, aluminum oxide, and zirconia.

18. The laminate of claim 17, wherein the at least one barrier layer comprises silicon nitride.

19. The laminate of claim 16, wherein the substrate comprises a glass substrate.

20. The laminate of claim 16, wherein the substrate comprises a glass substrate, the barrier layer comprises silicon nitride, and the laminate has antimicrobial and/or self-cleaning properties.

21. A titanium dioxide coated substrate having at least one of improved visible light transmission properties, improved haze properties, and improved reflectivity, wherein the titanium dioxide coated substrate is made by:
providing a substrate;
forming at least one barrier layer on the substrate;
preparing a titanium dioxide sol-gel composition;
coating the at least one barrier layer with the sol-gel composition; and
heating the coated substrate to form an anatase titanium dioxide coating.
